(19) United States
(12) Patent Application Publication
(10) Pub. No.: US 2006/0271459 A1
(43) Pub. Date: Nov. 30, 2006

(54) Efficient lifecycle investment and insurance methods, systems, and products

(76) Inventor: Jeffrey S. Lange, New York, NY (US)

Correspondence Address: SCHULTE ROTH & ZABEL LLP;ATTN: JOEL E. LUTZKER, 919 THIRD AVENUE, NEW YORK, NY, 10022, US

(21) Appl. No.: 11/139,873

(22) Filed: May 31, 2005

(51) Int. Cl. G06Q 40/00

(52) U.S. Cl. 705/35; 705/4

(57) ABSTRACT

This invention provides systems, methods, and designs for two novel life insurance products which provide many lifecycle investment advantages compared to existing state of the art products currently available.

### FIELD OF THE INVENTION

The present invention relates generally to systems, methods, plans and products for designing and providing investment products which are both investment and tax efficient across the lifecycle of an individual. In the theory of financial economics, lifecycle investing involves systematic investment planning throughout an individual's entire lifecycle in order to help best achieve one's financial objectives and goals. According to the well known Lifecycle Investment Theory of Nobel laureate Franco Modigliani, every individual passes through distinct stages in his lifecycle which are defined by characteristic and differing marginal utilities for saving and consumption. The first characteristic stage is the accumulation phase, during which an individual has higher marginal utility for consumption but constrained or limited resources. This phase is marked by dissaving by the individual, as he spends more by way of loans than he earns to meet his multiple needs. The second characteristic phase in an individual's lifecycle is the consolidation phase wherein the individual has satisfied most of his essential needs and is looking at opportunities of incremental wealth generation. This phase is marked by a higher marginal utility of wealth currently or, in other words, an intertemporal substitution of consumption whereby deferred consumption is deemed to have higher utility. In this stage, individuals typically exhibit net saving. The third and fourth phases are often referred to as the spending and gifting stages, respectively. These phases are again marked by dissaving as an individual eats into his earlier savings to meet up with his remaining lifecycle. As an individual evolves through these stages in his lifecycle, not only do his financial objectives and goals change, but also his risk bearing ability, which largely determines the feasible set of investment choices at each stage. The aim of the present invention is to provide novel methods, systems and products for lifecycle investment which efficiently achieve these changing investment goals. Throughout the description of this invention the term efficiency includes both market or pure investment efficiency which is a function of the expected returns and volatilities of the feasible set of investment choices, and tax efficiency, which refers to providing investment methods, systems, and products which produce a large after-tax source of wealth under the U.S. Internal Revenue Code.

### BACKGROUND OF THE INVENTION

A number of uses for life insurance products have emerged in recent years to fulfill many lifecycle investment objectives. Various types of life insurance have a dual savings and bequest objective which reflect the demand for deferred consumption in one's own lifetime and for the lifetime of one's beneficiaries. Recent innovations, such as variable universal life (VUL) insurance, bundle investment accounts together with yearly renewable term insurance. In this product, individuals may invest in a range of securities, mutual funds, or other types of investment partnerships in segregated investment accounts. The accounts are nominally owned by the issuing life insurance company. As a consequence, the owner of a variable universal life insurance policy pays no current income tax on investment returns. The death benefit of a VUL policy will generally increase as positive investment returns are accumulated. If the individual dies, this increased death benefit is paid out free of income tax to the VUL policy's beneficiaries. If the owner of the policy makes a withdrawal from the VUL policy prior to death, ordinary income tax is due on any earnings in the policy. Thus, a VUL policy bundles together the following components: (1) tax preferred growth of assets for either the individual (tax deferred withdrawals) or the individual's beneficiaries (tax free death benefits); (2) a layer of yearly renewable term insurance which is responsive to the overall growth in the investment accounts; (3) a mechanism by which the layer of term insurance can be paid for with before tax dollars through automatic deductions in the investment accounts.

A VUL policy is therefore a bundle of what financial economists call contingent claims. A pure contingent claim is a non-interest bearing security which pays out a unit of account (i.e., a dollar) should a given state of the world occur. For example, pure term life insurance pays out a certain quantity of dollars upon the death of an individual. Financial economists generally recognize that it is preferable to have a complete set of elementary (i.e., unbundles) contingent claims from which individuals can choose to fulfill their lifecycle investment objectives. (See, e.g., Lange and Economides, “A Parimutuel Market Microstructure for Contingent Claims,” European Financial Management, vol. 10:4, December 2004, and references cited therein). It is also generally recognized that bundling of contingent claims is generally a redundant exercise, however, bundling may be advantageous due to transaction cost and tax efficiency. For example, a VUL policy is a bundling of a tax deferred investment account and a term life insurance policy. An individual might be able to achieve the same objectives satisfied by a VUL policy by investing in a tax deferred 401(k) account and buying yearly renewable term insurance. Prima facie, the combination of the 401 (k) and the term insurance appears to achieve the same objectives as the VUL policy: tax free accumulation of investment returns available for withdrawal at a future date and an income tax free death benefit for beneficiaries. However, the VUL policy dominates for two reasons. First, were an individual to attempt to replicate a VUL policy with a 401(k) account and yearly renewable term insurance, they would find that the premiums paid on the term insurance must be made from after tax dollars. Section 264 of the Internal Revenue Code provides that these premiums are not tax deductible. In the VUL policy, by contrast, the premiums which keep the insurance portion of the VUL policy in force are automatically deducted on a monthly basis from the investment account. To the extent the investment account has returns, the premiums for the insurance are paid with pre-tax dollars since the returns from the VUL policy investment accounts accrue free of income tax. Second, replicating the VUL policy with a 401(k) and yearly renewable term insurance will incur significant transaction costs as the individual must dynamically “rebalance” the ratio of the balance in the 401 (k) versus the amount of term insurance. The VUL policy does this type of rebalancing automatically according to well-known and relatively efficient procedures. There is, however, a cost to bundling in the VUL policy: the Internal Revenue Code requires a minimum ratio of insurance to the balance in the VUL investment account in order for the VUL policy to meet the definition of insurance under Title 26, Section 7702. If this minimum ratio is requirement is not met, then the investment account returns will not receive the benefit of tax-free accumulation and the death benefit will be free from income tax. It is an object of the present invention to provide a variable life insurance policy which both complies with Section 7702 and yet has more flexible minimum ratios of death benefits to investment account balances. It is another object of the present invention to use the novel VUL policy described herein as a lifecycle investment product that can be used to maximize tax efficiency for groups of affiliated individuals, such as the managers or employees of a corporation, a group of alumni of a university or college, or an association of benefactors bound by the common aim of desiring to support a given charitable cause or institution.

Another type of insurance product which is often used to satisfy lifecycle investment objectives is an immediate annuity (or SPIA which stands for Single Premium Immediate Annuity). Conceptually, an immediate annuity is a unique type of contingent claim in that it allocates dollars to a certain state of the world where the owner of the immediate annuity has increased longevity. Thus, where a pure term life insurance policy can be viewed as an elementary contingent claim paying some number of dollars in the state of the world where the insured dies, an immediate annuity is a contingent claim, which pay some number of dollars should the annuity owner not die. It is clear that together, both an immediate annuity and a pure term insurance policy provide a complete set of continent claims for an individual to shift wealth from “alive” states to “dead” states or vice versa. A simple equation relates these two contingent claims as follows:
L+A=B

where L is a pure term insurance policy which pays one dollar upon the death of the insured, A is a pure immediate annuity which pays one dollar should the annuitized individual (the individual whose life is used to determine the payment of an annuity is often called the “measuring life”), and B is the sum of these two claims. As can be seen, if B is the sum of the L and A, since the individual is either alive or dead, B is a simple zero coupon bond which pays one dollar at date at a maturity date corresponding to the future date at which one determines whether the individual is alive or dead.

In practice, one cannot currently purchase a pure annuity like the quantity A, defined above, which pays a unit of account should an individual survive to a given future date. SPIA's are the closest analogue to such a claim but there are significant differences between SPIA's and the theoretical quantity A. First, under the Internal Revenue Code, a SPIA is a type of financial instrument which makes periodic (e.g., monthly, quarterly, annual) payments to the annuity payee. The pure annuity claim A, described above, makes only a single payment contingent upon surviving to some future date (which we may aptly call herein a “survivorship contingent claim” as opposed to pure term insurance with may aptly be called herein a “death contingent claim”) and would likely not qualify as an annuity (immediate or otherwise) under the Internal Revenue Code. Second, under the Internal Revenue Code, an immediate annuity must start making its periodic payments within 12 months of its purchase. The survivorship contingent claim (SCC), A, may pay one unit of account (e.g., dollar) should the insured be alive at some future date. Conceptually, there is no reason why this future date cannot be more than one year into the future. In fact, as described herein below, if the SCC can pay many years or even decades into the future, then such a claim can satisfy many lifecycle investment objectives. One object of this invention, therefore, is to provide a survivorship contingent claim which is both compliant with the current Internal Revenue Code and which can satisfy these investment objectives. Such an insurance product does not currently exist and can be crudely approximated, if at all, using existing products. For example, from the above equation we see that the SCC denoted A and the death contingent claim (DCC) denoted L, both sum to a discount or zero coupon bond B which matures at the future date referenced by L and A. Namely, if L pays one dollar should the insured be dead on Jan. 1, 2040 and A pays one dollar should the insured be alive on Jan. 1, 2040, then B is simply a zero coupon bond which matures on Jan. 1, 2040. By rearranging the equation relating L, A, and B, we see that A is equal to B−L, which means that a pure survivorship contingent claim is equal to a zero coupon bond less a pure death contingent claim. Using the parlance of the financial markets, the SCC, A, is equivalent to owning or being “long” the zero coupon bond, B, which matures on Jan. 1, 2040, and selling or being “short” the DCC which pays one dollar if the insured individual is dead on Jan. 1, 2040. As one object of the invention is to provide a practical and efficient survivorship contingent claim and since such a claim is equivalent to the insured selling or being short a death contingent claim-a type of life insurance contract analogous (but not exactly) to term life insurance, we present invention provides methods, systems and products for incorporating a means whereby an individual by effectively “short” life insurance on his own life. While individuals may currently sell life insurance which they already own (called a “life settlement” contract), we are unaware of any insurance product which effectively allows the insured to short a long dated pure life insurance claim on his own life. In addition, no proposals for such a claim which are compliant with current practice and the Internal Revenue Code have been made.

### SUMMARY OF THE INVENTION

The present invention provides methods, systems and products to solve the following problems or deficiencies facing an individual who desires to use insurance and investment products to meet lifecycle objectives:
(1) Current products, such as variable universal life insurance, require relatively large amounts of pure life insurance per dollar of investment account in order to comply with the Internal Revenue Code's definition of life insurance;
(2) Current VUL products cannot therefore be used effectively by a group of affiliated individuals sharing a common situation, purpose or goal, to invest with maximum tax efficiency at minimum insurance cost;
(3) Current VUL products provide for too large a minimum net amount at risk or corridor which requires extensive medical underwriting and usage of an individual's insurable capacity in order to receive the benefits of tax-free accumulation and death benefits;
(4) Current insurance products do not offer a pure survivorship contingent claim which enables an individual to effectively short life insurance on his own life;
(5) Current insurance products do not provide for annuities paying either a lump sum or period payments conditional upon the survival of the insured more than 12 months from the date of purchase as currently required by the Internal Revenue Code.

The aim of the present invention is to solve these problems by providing methods, systems and products which accomplish these investment and insurance objectives while satisfying all requirements under the existing Internal Revenue Code.

A need is recognized for a new variable universal life insurance product which allows for a design which generates a lower net amount of death benefit (referred to as the “corridor”) under the Internal Revenue Code, section 7702.

A need is recognized for a new variable universal life insurance product which can specify the payment of death benefit proceeds upon a variety of contingent events other than the traditional death of a single insured, first death of two joint insureds, or second death of two joint insureds.

A need is recognized for a new variable life insurance product which incorporates multiple events the duration of which can survive much longer than life insurance products currently offered.

A need is recognized for a new variable life insurance product which provides for efficient downside protection of the variable investment account using a novel death benefit mechanism described herein.

A need is recognized for a new variable life insurance product which provides the ability of a group of university or college alumni to be able to invest in investment accounts managed by their university or college's endowment management company without adverse tax consequences while providing maximum flexibility with respect to donative goals.

A need is recognized for a new variable life insurance product whereby a plurality of individuals can be insured and whereby the event triggering the death benefit payment can be specified in a manner which dramatically shortened the statistical expected time to payment.

A need is recognized for a new variable life insurance product which does not require medical underwriting irrespective of the size of the premiums paid into such policy and which, once underwritten, would not impede the individuals insured from obtaining large amounts of insurance at some future date under another policy.

A need is recognized for an annuity financial product that is both compliant with the current Internal Revenue Code and which can begin making lump sum or periodic payments greater than one year from the date of purchase.

A need is recognized for a survivorship contingent claim which pays a unit of account should the insured survive to a given future date.

A need is recognized for an annuity product which combines the following features: (1) a survivorship contingent claim; (2) a payment or payments to be made greater than one year from the date of purchase; and (3) periodic payments that are guaranteed to be a defined amount, or no less than a defined amount, at the time of purchase; (4) periodic payments that are largely excluded from income tax under the current Internal Revenue Code.

According to one embodiment of the present invention, as described herein, a method, system and product for a multiple event variable universal life insurance (MEVUL) policy which provides minimal or no corridor, is compliant with Section 7702 of the Internal Revenue Code, and has a duration that can exceed the lifetime of any given individual comprises the steps of:
1) determining more than one insured to be insured under the life insurance contract;
2) selecting “reasonable mortality charges” pursuant to Section 7702 of the Internal Revenue Code and regulations thereunder corresponding to the lives of the insureds under the contract;
3) defining the event under which the insurance contract will pay a death benefit as a function of the-death, survivorship, or both of individual or multiple insureds (the “payment event”) and
4) providing for the ability of surviving insureds to maintain the policy in force upon the payment of a death benefit triggered by a payment event.

According to another embodiment of the present invention, a method, system and product for providing very efficient retirement income tax-free annuities (“VERITAS”) comprising the steps of:
1) selecting an annuity purchase date and an annuity payment date whereby the payment date can be greater than 12 months later than the annuity purchase date;
2) selecting a traditional variable annuity contract containing cash surrender, death benefit and nonforfeiture benefits;
3) removing the cash surrender, death benefit and nonforfeiture benefits from the traditional annuity contract to create a new contract without such benefits;
4) specifying one or more unit investment trusts or similar investment trusts or entities to be the segregated investment accounts of the variable annuity;
5) specifying one or more measured lives for the variable annuity contract for determining the date at which no death benefits are payable or the amount of lump sum or periodic payments to be made beginning at the annuity payment date;
6) funding the unit investment trusts of step (4) with tax preferred securities or other financial instruments such as long-dated zero coupon insured municipal bonds which have a high credit rating (e.g., AAA);
7) providing a guaranteed lump sum or periodic payments at the annuity payment date or providing that such payments may not be below a certain level at the annuity payment date;
8) computing the exclusion ratio determining the amount of the periodic payments, if any, which begin at the annuity payment date that are excludable from income tax under the current Internal Revenue Code;
9) publishing on a periodic basis (e.g., monthly), the guaranteed lump sum or periodic payments guaranteed at the annuity payment date or the lowest level of such payments given current market conditions.

In another additional embodiment of the present invention, a method comprising the financing of consideration for the VERITAS annuity described herein.

In another additional embodiment of the present invention, a method, system, and product accomplishing the same financial objectives of the VERITAS annuity but using a grantor trust rather than a traditional variable annuity contract as the payment and beneficiary mechanism under which payments are made at the annuity payment date.

### BRIEF DESCRIPTION OF THE DRAWINGS

FIG. 1 is a schematic representation of a system, method, and product for the MEVUL—a multiple event variable universal life for minimizing corridor, providing tax efficient investment returns, and a long duration lifecycle investment vehicle for multiple insureds.

FIG. 2 is a schematic representation of a system, method, and product for the VERITAS, a novel annuity product providing many lifecycle investment benefits.

### DETAILED DESCRIPTION

The present invention is described in relation to systems, methods, products and plans for the enablement of two lifecycle financial and insurance contracts. In the first such product, described above and named MEVUL for the purposes of the present invention, a novel variable life insurance product is described which provides the following benefits: (1) dramatically reducing or eliminating insurance corridor and the costly premiums associated with such corridor pursuant to either the cash value accumulation test (CVAT) or guideline premium test (GPT) under Section 7702 of the Internal Revenue Code; (2) provision of completely tax-free investment returns along with increased liquidity of those returns and principal; and (3) an option to maintain the contract with an “evergreen” feature under which its duration can be extended well beyond the duration of current insurance products; (4) the provision of multi-individual benefits to groups of affiliated individuals such as employees, executives, partners, or owners of a corporation or individuals sharing a common purpose such as the desire to support a given charitable cause or foundation; (5) the provision of the ability of multiple benefactors of a charitable institution, such as university or college alumni, to provide funds for the MEVUL product wherein such funds are managed by the alumni's university's or college's endowment management company wherein (a) the returns on such investments are entirely tax free and (b) the benefactors need to provide any other benefit to the university or college in the form of a gift of principal or interest from said investment of funds.

In the second such product, described above, and named VERITAS for the purposes of the present invention, a novel variable annuity insurance product is described which provides for the following lifecycle investment benefits: (1) annuitization into periodic payments that begin greater than 12 months from the annuity purchase date and yet which maintain a large exclusion ratio under current tax law; (2) the ability to increase future income for later consumption or retirement by incorporating multiple measured lives and multiple types of payment events; (3) the ability to increase future income for later consumption or retirement by providing no death benefits or cash surrender benefits or other nonforfeiture benefits; (4) the ability to provide AAA guarantees of both the investments inside the investment account and by the issuing insurance company providing for the highest degree of security of such future benefits.

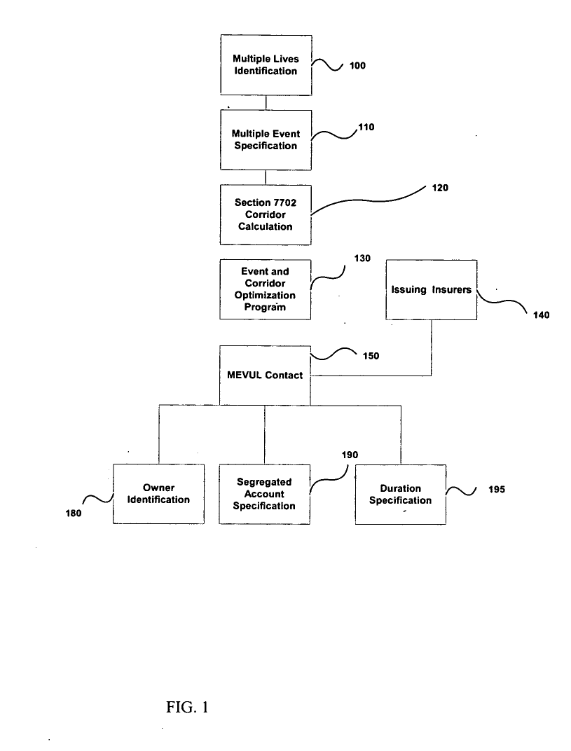

FIG. 1 is a schematic representation of a system and method for the creation of the MEVUL product, and a schematic illustration of the product itself. The system, method, or product, 100, may comprise a contract with the ability to identify multiple lives to serve as insureds. For example, the MEVUL contract may allow for 2 insureds or up to many hundred's of insureds under the same policy. For example, a husband and wife may be the insureds under a MEVUL policy or 500 alumni of a given university may be the insureds. The MEVUL product, along with systems and methods used to design and implement it, also comprise the identification of the event upon which payment of the death benefit will be made, 110. Depending upon the prior multiple lives identification step, 100, the event may, in a preferred embodiment, be a realization of a multivariate probability distribution. For example, assuming that the MEVUL product of the present embodiment were to be used by 500 university alumni and that these 500 alumni were the insureds under a single MEVUL policy, the multiple event specification, 110, may, in a preferred embodiment, specify the payment of a death benefit upon the death of the first alumnus. Alternatively, the death benefit of the policy may be paid upon the death of the 10^{th} alumnus out of 500. Based upon the multiple event specification step, 110, the next step is to calculate the net amount at risk or corridor required under the Internal Revenue Code, Title 26, Section 7702. There are two tests for the minimum net amount at risk or corridor under Section 7702: the Guideline Premium Test (GPT) and the Cash Value Accumulation Test (CVAT). Both tests aim to require that in order for a life insurance policy to qualify as “life insurance” under the Internal Revenue Code and therefore receive the income tax benefits of income tax-free accumulation and income tax-free death benefits, the policy must require a minimum ratio of total death benefit to policy cash value, or, in other words, a minimum difference between total death benefit and policy cash value, which is termed the corridor amount. For example, in computing this minimum corridor under the CVAT test (which generally allows greater amounts of policy cash earlier in the life of a policy but requires a higher corridor later), under Section 7702, the minimum corridor can be calculated using “reasonable mortality charges” and a 4% interest rate. The question answered by the CVAT test is: what is the minimum ratio of total death benefit to policy cash value that needs to be in place at any point in time for the life policy to qualify as life insurance under Section 7702. Both the CVAT and GPT test use similar principles in defining this requirement. Beginning with a single premium and a net amount at risk at a given insured's age using reasonable mortality charges the following procedure is performed (taking the CVAT test as an example in the present embodiment) per the Section 7702 corridor calculation step, 120:
1. Begin with 100 dollars of cash value;
2. Assume an additional corridor amount (e.g., 20% of 100 dollars=20 dollars);
3. Obtain “reasonable mortality charges” such as those derived from 1980 Commissioner Standard Ordinary (1980 CSO) mortality data;
4. At each year, first multiply the annual mortality charge (e.g., 3%) times the corridor amount;
5. Subtract the amount in Step 4 from cash value;
6. Accrue the remaining cash at the 4% interest rate specified under 7702;
7. Iterate by changing the initial corridor amount in Step 2 until the resulting policy cash plus corridor amount at age 100 is equal to the policy cash value plus corridor amount at the end of the year of the age of calculation.

The following table illustrates these values assuming 100 dollars of initial policy cash value for a 75 year old male nonsmoker using 2001 CSO mortality data:

TABLE 1
Section 7702 Corridor Calculation

| | | BOY | | EOY | | |
|---|---|---|---|---|---|---|
| Age of | 2001 | Policy | Policy Cash | Policy | Death | CVAT |
| Insured | CSO | Cash | Less COI | Cash | Benefit | Corridor |
| 75 | 2.50% | 100.00 | 98.83 | 102.78 | 149.52 | 46.74 |
| 76 | 2.74% | 102.78 | 101.50 | 105.56 | | |
| 77 | 3.01% | 105.56 | 104.16 | 108.32 | | |
| 78 | 3.35% | 108.32 | 106.76 | 111.03 | | |
| 79 | 3.76% | 111.03 | 109.27 | 113.64 | | |
| 80 | 2.95% | 113.64 | 112.26 | 116.75 | | |
| 81 | 3.23% | 116.75 | 115.24 | 119.85 | | |
| 82 | 3.52% | 119.85 | 118.20 | 122.93 | | |
| 83 | 3.85% | 122.93 | 121.13 | 125.98 | | |
| 84 | 4.19% | 125.98 | 124.02 | 128.98 | | |
| 85 | 4.56% | 128.98 | 126.85 | 131.92 | | |
| 86 | 4.99% | 131.92 | 129.59 | 134.77 | | |
| 87 | 5.47% | 134.77 | 132.21 | 137.50 | | |
| 88 | 5.99% | 137.50 | 134.70 | 140.09 | | |
| 89 | 6.62% | 140.09 | 137.00 | 142.48 | | |
| 90 | 7.10% | 142.48 | 139.16 | 144.72 | | |
| 91 | 7.74% | 144.72 | 141.11 | 146.75 | | |
| 92 | 8.53% | 146.75 | 142.77 | 148.48 | | |
| 93 | 9.33% | 148.48 | 144.12 | 149.88 | | |
| 94 | 10.15% | 149.88 | 145.14 | 150.94 | | |
| 95 | 10.99% | 150.94 | 145.81 | 151.64 | | |
| 96 | 11.80% | 151.64 | 146.13 | 151.97 | | |
| 97 | 12.64% | 151.97 | 146.06 | 151.91 | | |
| 98 | 13.47% | 151.91 | 145.61 | 151.44 | | |
| 99 | 14.11% | 151.44 | 144.84 | 150.64 | | |
| 100 | 14.70% | 150.64 | 143.77 | 149.52 | | |

In the first column of Table 1 is the age of the insured. The second column contains the “reasonable mortality charges” per dollar of net amount at risk or corridor amount under the 2001 CSO Tables. The 2001 CSO Tables are, as of 2004, gradually being adopted for use to replace the dated 1980 CSO Tables. The 2001 CSO Tables have mortality charges which are substantially lower than those of the 1980 CSO Tables, which generally reflects the improvement in longevity at most ages between the years 1980 and 2001 in the United States. As expected, the annual mortality charges shown above for a male from age 75 to 100 increase over the age range to reflect the increasing probability of mortality at older ages. To solve for the CVAT corridor for the end of the year at age 75 (in actual policy calculations, the CVAT corridor calculation is typically done monthly but here it is done annually for illustrative purposes), an initial corridor amount is assumed. The cost of insurance (“COI”) is then equal to the initial corridor amount multiplied by the 2001 CSO mortality charge for that age as shown in column 2 of Table 1. The initial policy cash of 100, shown in column 3 of Table 1 above, when reduced by this COI is shown in column 4 above. Per Section 7702, the amount in column 4 is accrued at the statutory interest rate of 4%. The result is shown in column 5 of Table 1 which is the end of year policy value which reflects deductions for cost of insurance and then accruing 4% interest on the balance. The calculations are carried forward until age 100. The initial corridor amount chosen is iteratively changed until the end of year policy cash at the age of calculation (age 75 in this illustration) plus the corridor amount is equal to the end of year policy cash (column 5, Table 1) at age 100. As can be seen, the resulting calculation is equal to 149.52 which is the gross death benefit required when the policy begins with 100 in premium and grows to 102.78 in cash at the end of the first year. The difference between the gross death benefit and the end of year policy cash is 149.52 minus 102.78 or 46.74, which is the corridor amount. Typically, the corridor would be expressed as 100 plus the amount divided by 100, or 1.47 rounding to the nearest tenth.

In a preferred embodiment, the Section 7702 Corridor Calculation step, 120, is responsive to the Multiple Life Identification step, 100, and the Multiple Event Specification step, 110. To show this, we consider the following example of the preferred embodiment step. First, we consider the case where the Multiple Life Identification step, 100, identified 100 individuals all of whom are 50 year old non-smoking males. Second, we consider the case where the Multiple Event Specification step, 110 specified the death benefit payment event to be the first death among these 100 insureds (a so-called “first to die” event). Under Section 7702, “reasonable mortality charges” must be used for each of the 50 year old non-smoking males. Typically, at of 2004, these are 1980 CSO table charges. However, as the new 2001 CSO tables will soon be adopted as of the date of the present invention, the newer mortality charges, which reflect improved longevity between 1980-2001, will be used. Using the standard actuarial notation:
q_{t,T}=the probability of death between time t and T conditional upon survival to time t
p_{t,T}=the probability of survival between time t and T, conditional upon survival to time t

As is commonly used, if the period of death and survival is taken to be a calendar year, the shorthand, qₜ and pₜ will be used respectively, where the second subscript, T, is implicitly understood to be equal to t+1 year. So, for example, q₅₀ is the probability that a 50 year old of a given risk class (make, nonsmoker, select) dies in the next calendar year while p65 is the probability that a 65 year old of a given risk class survives in the next year. For step 120 of FIG. 1, the first substep is to acquire the qₜ for the given risk class which are available, for example, from the 2001 CSO tables. Since mortality charges are proportional to qₜ, we will assume, for sake of convenience, that the qₜ also represent the fair cost of insurance for an individual of age t in the given risk class. From the 2001 CSO tables, the qₜ for a 50 year old male nonsmoker is equal to:

TABLE 2
2001 CSO Mortality Rates for Male Nonsmokers Aged 50-100

| | Annual Mortality |
|---|---|
| Age | Charges |
| 50 | 0.146% |
| 51 | 0.180% |
| 52 | 0.216% |
| 53 | 0.256% |
| 54 | 0.297% |
| 55 | 0.349% |
| 56 | 0.414% |
| 57 | 0.485% |
| 58 | 0.551% |
| 59 | 0.626% |
| 60 | 0.717% |
| 61 | 0.828% |
| 62 | 0.951% |
| 63 | 1.085% |
| 64 | 1.226% |
| 65 | 1.376% |
| 66 | 1.499% |
| 67 | 1.613% |
| 68 | 1.757% |
| 69 | 1.958% |
| 70 | 2.222% |
| 71 | 2.532% |
| 72 | 2.869% |
| 73 | 3.227% |
| 74 | 3.577% |
| 75 | 4.003% |
| 76 | 4.413% |
| 77 | 4.889% |
| 78 | 5.445% |
| 79 | 6.087% |
| 80 | 6.787% |
| 81 | 7.58% |
| 82 | 8.41% |
| 83 | 9.31% |
| 84 | 10.30% |
| 85 | 11.41% |
| 86 | 12.63% |
| 87 | 13.97% |
| 88 | 15.41% |
| 89 | 16.93% |
| 90 | 18.51% |
| 91 | 19.99% |
| 92 | 21.54% |
| 93 | 23.18% |
| 94 | 24.91% |
| 95 | 26.72% |
| 96 | 28.38% |
| 97 | 30.15% |
| 98 | 32.04% |
| 99 | 34.05% |

As can be seen, the mortality charges increase with age at an increasing rate. As is known to one skilled in the art, there are relationships between the annual probabilities of death and the survival probabilities as follows:

$${p}_{t , T} = {\prod }_{i = t}^{i = T} ( 1 - {q}_{i} )$$

That is, the probability of surviving from time t to T is the product of one minus the probability of dying in each year from t to T. Similarly, the probability of dying between t and T is the probability of dying in the first year, plus the probability of surviving in the first year multiplied by the probability of dying in the second year, and so forth as follows:

$${q}_{t , T} = {\sum }_{i = t}^{i = T} {q}_{i} {\prod }_{t}^{i = T - 1} ( 1 - {q}_{i} )$$

If the event defined in step 110 of FIG. 1 is “first to die” the step 120 of FIG. 1 entails computing the first to die mortality charges. Since it is assumed for the purposes of simplicity of description that the annual mortality charges are equal to the annual probabilities of mortality, the probability of a first death in a given year beginning at time t for N insureds is equal to, in the first year, one minus the probability that all the individuals survive. In the second year, the probability of a first death in year two is equal to one minus the product of the probability that all survived in year one and the probability that all survived in year 2, less the probability that all survived in year 1. In the standard notation, and assuming that the probability of death of each individual is statistically independent this is equal to the probability that all insureds survive to time T−1 and then not all survive at time T or:

$${q}_{t , T}^{n} = {\prod }_{i = t}^{i = T - 1} {( 1 - {q}_{i} )}^{N} ( 1 - {( 1 - {q}_{T} )}^{N} )$$

For annual mortality rates, the formula reduces to
qₜⁿ=(1−(1−qₜ)^{N})

Using this formula on the 2001 CSO mortality rates in Table 2, yields the Section 7702 reasonable mortality charges for 50 insureds (N=50) each of whom is 50 years old:

TABLE 3
2001 CSO Mortality Rates for Male Nonsmokers
Aged 50-100: First to Die

| | Annual Mortality |
|---|---|
| Age | Charges |
| 50 | 7.04% |
| 51 | 8.61% |
| 52 | 10.25% |
| 53 | 12.03% |
| 54 | 13.82% |
| 55 | 16.04% |
| 56 | 18.73% |
| 57 | 21.58% |
| 58 | 24.14% |
| 59 | 26.95% |
| 60 | 30.22% |
| 61 | 34.01% |
| 62 | 37.98% |
| 63 | 42.04% |
| 64 | 46.03% |
| 65 | 49.98% |
| 66 | 53.01% |
| 67 | 55.65% |
| 68 | 58.78% |
| 69 | 62.79% |
| 70 | 67.49% |
| 71 | 72.26% |
| 72 | 76.67% |
| 73 | 80.60% |
| 74 | 83.82% |
| 75 | 87.03% |
| 76 | 89.53% |
| 77 | 91.84% |
| 78 | 93.92% |
| 79 | 95.67% |
| 80 | 97.02% |
| 81 | 98.06% |
| 82 | 98.77% |
| 83 | 99.24% |
| 84 | 99.56% |
| 85 | 99.77% |
| 86 | 99.88% |
| 87 | 99.95% |
| 88 | 99.98% |
| 89 | 99.99% |
| 90 | 100.00% |
| 91 | 100.00% |
| 92 | 100.00% |
| 93 | 100.00% |
| 94 | 100.00% |
| 95 | 100.00% |
| 96 | 100.00% |
| 97 | 100.00% |
| 98 | 100.00% |
| 99 | 100.00% |

As can be seen from Table 3, the annual mortality charges for the first to die event for fifty 50 year old male nonsmokers is very high compared to the charges for a single male. To finish the example computation per step 120 of FIG. 1, the corridor calculation using these mortality charges under Section 7702 yields:

TABLE 4
Section 7702 Corridor Calculation for Fifty Insureds: First to Die

| | | BOY | Policy | EOY | | FTD |
|---|---|---|---|---|---|---|
| FTD | 2001 | Policy | Cash Less | Policy | Death | CVAT |
| Age | CSO | Cash | COI | Cash | Benefit | Corridor |
| 51 | 0.070449 | 100.00 | 99.48 | 103.46 | 110.85 | 7.39 |
| 52 | 0.086143 | 103.46 | 102.82 | 106.94 | | |
| 53 | 0.102477 | 106.94 | 106.18 | 110.43 | | |
| 54 | 0.120291 | 110.43 | 109.54 | 113.92 | | |
| 55 | 0.13819 | 113.92 | 112.90 | 117.41 | | |
| 56 | 0.160379 | 117.41 | 116.23 | 120.88 | | |
| 57 | 0.18733 | 120.88 | 119.49 | 124.27 | | |
| 58 | 0.215799 | 124.27 | 122.68 | 127.58 | | |
| 59 | 0.241386 | 127.58 | 125.80 | 130.83 | | |
| 60 | 0.269469 | 130.83 | 128.84 | 134.00 | | |
| 61 | 0.302178 | 134.00 | 131.76 | 137.03 | | |
| 62 | 0.340137 | 137.03 | 134.52 | 139.90 | | |
| 63 | 0.379839 | 139.90 | 137.10 | 142.58 | | |
| 64 | 0.420428 | 142.58 | 139.47 | 145.05 | | |
| 65 | 0.460325 | 145.05 | 141.65 | 147.32 | | |
| 66 | 0.499815 | 147.32 | 143.62 | 149.37 | | |
| 67 | 0.530071 | 149.37 | 145.45 | 151.27 | | |
| 68 | 0.556508 | 151.27 | 147.16 | 153.04 | | |
| 69 | 0.587826 | 153.04 | 148.70 | 154.65 | | |
| 70 | 0.627944 | 154.65 | 150.01 | 156.01 | | |
| 71 | 0.67487 | 156.01 | 151.02 | 157.06 | | |
| 72 | 0.722602 | 157.06 | 151.73 | 157.79 | | |
| 73 | 0.766712 | 157.79 | 152.13 | 158.21 | | |
| 74 | 0.806041 | 158.21 | 152.26 | 158.35 | | |
| 75 | 0.83818 | 158.35 | 152.16 | 158.24 | | |
| 76 | 0.870317 | 158.24 | 151.81 | 157.88 | | |
| 77 | 0.895301 | 157.88 | 151.27 | 157.32 | | |
| 78 | 0.918429 | 157.32 | 150.53 | 156.56 | | |
| 79 | 0.939155 | 156.56 | 149.62 | 155.60 | | |
| 80 | 0.95672 | 155.60 | 148.53 | 154.47 | | |
| 81 | 0.970227 | 154.47 | 147.31 | 153.20 | | |
| 82 | 0.98062 | 153.20 | 145.95 | 151.79 | | |
| 83 | 0.987656 | 151.79 | 144.49 | 150.27 | | |
| 84 | 0.992445 | 150.27 | 142.94 | 148.66 | | |
| 85 | 0.995639 | 148.66 | 141.30 | 146.95 | | |
| 86 | 0.997656 | 146.95 | 139.58 | 145.17 | | |
| 87 | 0.998833 | 145.17 | 137.79 | 143.30 | | |
| 88 | 0.999461 | 143.30 | 135.91 | 141.35 | | |
| 89 | 0.999768 | 141.35 | 133.96 | 139.32 | | |
| 90 | 0.999906 | 139.32 | 131.93 | 137.21 | | |
| 91 | 0.999964 | 137.21 | 129.82 | 135.01 | | |
| 92 | 0.999986 | 135.01 | 127.63 | 132.73 | | |
| 93 | 0.999995 | 132.73 | 125.34 | 130.36 | | |
| 94 | 0.999998 | 130.36 | 122.97 | 127.89 | | |
| 95 | 0.999999 | 127.89 | 120.50 | 125.32 | | |
| 96 | 1 | 125.32 | 117.93 | 122.65 | | |
| 97 | 1 | 122.65 | 115.26 | 119.87 | | |
| 98 | 1 | 119.87 | 112.48 | 116.98 | | |
| 99 | 1 | 116.98 | 109.59 | 113.97 | | |
| 100 | 1 | 113.97 | 106.58 | 110.85 | | |

As can be seen from Table 4 in comparison with Table 1, the Section 7702 CVAT corridor mandates approximately 7.39 dollars of insurance for every 100 dollars of initial (beginning of first year) cash value for fifty 50 year old male nonsmokers under the 2001 CSO reasonable mortality charges. By comparison, a single 75 year old requires under Section 7702 approximately 46.74 dollars of insurance per 100 dollars of initial premium. So the first to die corridor as an event defined per step 110 of FIG. 1 combined with multiple lives per step 100, can produce, in a preferred embodiment, dramatically reduced corridors under Section 7702. Effectively, the first to die event specification combined with numerous lives produces mortality charges commensurate to that of an individual much older than each constituent individual insured under the first to die even specification, per step 110 of FIG. 1. Thus, in a preferred embodiment, one goal and aim of steps 100-120 is to reduce the corridor amount for a group of younger individuals while satisfying the statutory requirements of Title 26 Section 7702.

Referring again to FIG. 1, step 130 represents a program which optimizes the corridor amount under Section 7702 by varying, in a preferred embodiment, such variables as (1) the number of insureds pursuant to step 100 of FIG. 1; (2) the age and variance of the insureds ages, again pursuant to step 100; (3) the risk class of the insureds, again pursuant to step 100; and (4) the event at which the death benefit is paid under the policy pursuant to step 120. The objective function of optimization program, 130, might be to minimize the corridor amount, subject to constraints such as (a) having no more than a given number of insureds; (b) having no insured being older than a certain age; (c) having the standard deviation of the expected time to the first death benefit payment date be no greater than certain exogenously specified amount (e.g., “10 years”); and (d) having the expected time to the first death benefit payment date be no greater than a certain amount. Such a program would have the following structure in a preferred embodiment:

$${min}_{N , {x}_{j}} C ( N , {x}_{j} , {q}_{i}^{j} ( {x}_{j} ) )$$

$$subject to$$

$$N \leq α$$

$${x}_{j} \leq m$$

$$EV ( First Payment Date ) \leq τ$$

$$STD ( First Payment Date ) \leq s$$

where EV stands for “expected value” and STD stands for “standard deviation” as computed under the multiple event probabilities (e.g., first to die event) pursuant to the procedure described above. This event and corridor optimization program, as described above in a preferred embodiment, can be solved using nonlinear programming techniques.

Referring again to FIG. 1, step 140, shows the process of a life insurance company, rated Standard and Poor's claims paying AA or better in a preferred embodiment (though it may be rated lower in alternative embodiments) issuing the MEVUL contract, a variable universal life contract designed according to the steps described above, 150. As designed pursuant the preferred embodiment described above, the issuing insurer, 140, will need to get approval for the MEVUL contract, 150, in states where the contract is offered for sale. In an alternative embodiment, the issuing insurer, 140, may be an offshore life insurance company domiciled outside the United States (e.g., Bermuda) and therefore no such state approval is required. In this embodiment, the MEVUL contract, 150, as described here in is a novel multiple event, multiple insured, variable universal insurance policy that would be privately placed in the private placement offshore insurance market.

Referring again to FIG. 1, owner identification step, 180, identifies the legal MEVUL life insurance policy owner. Specification of the owner is important since it (1) determines whether the owner has insurable interest; (2) whether the variable contract may qualify as life insurance under the owner control portions of the Internal Revenue Code, Title 26, section 817 (and regulations thereunder). In a preferred embodiment, if the multiple insureds are employees of, for example, a corporation, or are members of a partnership, both the state law insurable interest requirements and the Internal Revenue Code investor control requirements would be met if either the individuals own a respective share of the policy or the corporation or partnership, respectively, provided that neither the individuals nor the business entities are responsible for the day to day management of the MEVUL's segregated accounts. The segregated accounts are specified in 190. In a preferred embodiment, this step may be selecting various mutual funds, hedge funds, or other types of investment partnerships. The segregated accounts themselves may contain entities which are invested in life insurance policies and annuities. In a preferred embodiment, the specification of the segregated accounts and the account managers are related to the multiple lives identification, 100, and owner identification step, 180. In such an embodiment, the segregated investment accounts may be selected to be those managed by an nonprofit institution such as a university or college. For example, step 190, may specify that Stanford Management Company or Harvard Management Company will manage the segregated account of the MEVUL in a manner similar to how these management companies currently manage their endowments. Recently, there has been substantial demand by alumni and other supporters of these institutions for the institutions' management companies to manage their assets. For example, both Stanford Management Company (SMC) and Harvard Management Company (HMC) both have Charitable Remainder Unitrust (CRUT) programs whereby supporters of the respective universities may invest capital into the CRUT, receive the returns earned by the respective management companies, and then, upon the death of the CRUT grantor, the principal of the CRUT reverts to the respective university. There are a number of problems with this method of investing in the same manner as SMC, HMC and similar institutions. First, CRUTs entail the entire or substantial portion of a gift of principal to the respective nonprofit foundations. Second, because sophisticated management companies such as SMC and HMC use debt-financing (leverage) in managing their assets, such activity results in Unrelated Business Taxable Income (UBTI). Until recently, the CRUTs could not maintain their entirely tax-free status and participate in the endowment management's use of debt-financing. In a recent IRS Private Letter Ruling, however, the Harvard Management Company asked the IRS to allow its CRUT assets to be able to participate in its debt-financed strategies, provided that HMC paid the UBTI on behalf of the CRUTs (see “IRS Rule Helps People Put Their Trust in Harvard,” New York Times, Jan. 16, 2004). The method, system, and product of the present invention provides a superior means by which alumni and other supporters may receive investment returns generated by the respective endowment management companies without strict charitable donation requirements or complications related to UBTI. For example, in a preferred embodiment, the segregated account specification step, 190, may select various funds managed by an endowment management company such as SMC or HMC. These funds would have to be available only within a segregated life insurance policy account pursuant to the Internal Revenue Code, Section 817 (and regulations promulgated thereunder). A number of alumni may be specified as the insured lives pursuant to step 100 of FIG. 1. For example, 50 alumni may be named the insureds. Pursuant to step 110, the payment of the death benefit may be due upon the first death among the 50 insureds. If, for purposes of illustration, each alumnus were 50 years old, then by step 120 the corridor is very small compared to the initial amount of premium put into the policy (the 50 alumni may divide the initial premium among themselves). For example, for each 100 dollars of premium which the 50 alumni put into the policy at policy inception, the corridor requirement under Section 7702 of the Internal Revenue Code is approximately only 7.4% of the initial premium. When the death benefit is paid, it will be free of all tax, including UBTI. Referring to step 195 of FIG. 1, the duration of the MEVUL contract is specified. For illustrative purposes, the expected time to first death for a first to die event specification for fifty insureds each of whom is aged 50 is about 6.7 years. So, the surviving 49 insureds and the estate of the deceased insured will split the death benefit according to their initial premium contributions or in another manner agreed by them, on average, in 6.7 years. A significant advantage, then, of the method and systems proposed to design and offer the MEVUL contract is a relatively short time for the MEVUL contract to mature and provide liquidity for the owners of the contract. In addition, pursuant to step 195, another advantage in a preferred embodiment is to have an “evergreen” feature of the MEVUL by which the surviving insureds (e.g., 49 in this example) will automatically be insured in a reinstatement of a new death benefit which is responsive to the amount of premium that the surviving 49 insureds and/or the owner of the contract desired to rollover to insure the survivors. In a prefefred embodiment, such a rollover feature might be automatic. In another embodiment, the default rollover might be the initial premium invested, whereby any accumulated earnings or death benefit in excess of the initial premium might be rolled over at the election of the insureds and/or the owners of the MEVUL. In another preferred embodiment, an additional insured may be added to the existing number of insureds. In another preferred embodiment, the initial underwriting of the insureds will not require medical examinations or other invasive information from the insureds due to the modest net amount of insurance risk or corridor of the contract, per steps 120 and 130.

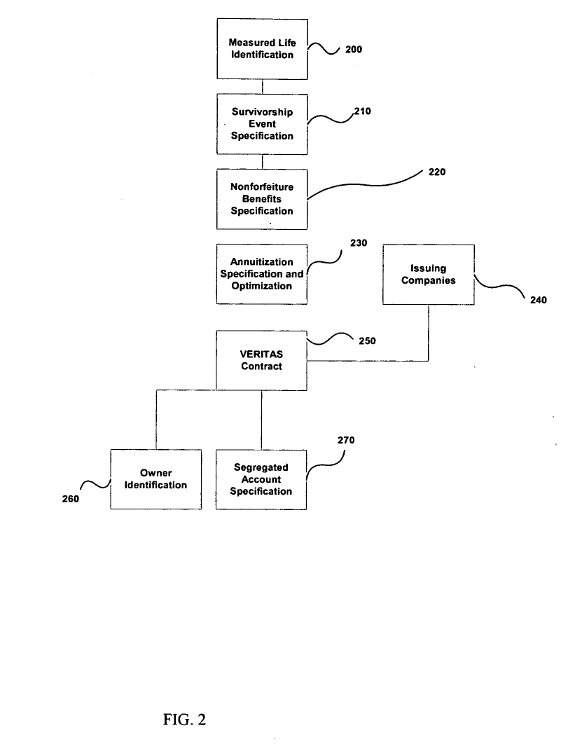

Referring to FIG. 2, a schematic representation of a system and method for the creation of the VERITAS product, and a schematic illustration of the product itself is shown. VERITAS, for the purposes of the present invention, is a novel variable annuity insurance product is described which provides for the following lifecycle investment benefits: (1) annuitization into periodic payments that begin greater than 12 months from the annuity purchase date and yet which maintain a large exclusion ratio under current tax law; (2) the ability to increase future income for later consumption or retirement by incorporating multiple measured lives and multiple types of payment events; (3) the ability to increase future income for later consumption or retirement by providing no death benefits or cash surrender benefits or other nonforfeiture benefits; (4) the ability to provide AAA guarantees of both the investments inside the investment account and by the issuing insurance company providing for the highest degree of security of such future benefits.

Referring to FIG. 2, step 200 is the measured life identification step whereby the measured lives-the individuals whose lifespans determine the payments under the VERITAS contract-are identified. For example, pursuant to step 200, the measured life might be a 50 year old male nonsmoker. As another example, there might be two measured lives, e.g., a husband and wife. As another example and in a preferred embodiment, there might be many measured lives. For example, a group of 50 employees, partners, or alumni of a given university be identified as the measured lives.

The survivorship event specification, 210, in FIG. 2 specifies the event that must occur in order for the annuity to make payments at the annuity date. For each VERITAS contract, there is purchase date at which time the consideration or purchase price for the contract is due, and an annuitization or annuity date, at which point the contract begins, in a preferred embodiment, to make periodic payments. Since, in a preferred embodiment, the VERITAS product is designed to maximize periodic payments which commence at a future date, the survivorship event specification will typically specify the number of measured lives that must survive to the annuitization date in order for benefits to be payable. If the survivorship condition is not met, then, in a preferred embodiment, no benefits may be payable (for example, death benefits to a beneficiary). As an example, there may be a single measured life as specified in step 200. Assume, for sake of illustration, that this single measured live is a 50 year old male nonsmoker. The survivorship event specification step, 210, then might require the 50 year old to survive to age 70 in order for benefits to be payable. Alternatively, where there is a husband and wife as the measuring lives per step 200, the survivorship specification step, 210, might specify that both must survive to age 65 in order for benefits to become payable. As yet another example, a group of 10 alumni of a university may serve as the measuring lives per step 200. The survivorship event specification step, 210, might specify that payments are to begin only if all 10 alumni survive to the age of 60. Another such even involving 10 alumni might be that benefits will be payable at a given future annuitization date should no fewer than 8 alumni survive to the annuitization date. Clearly, there are many combinations of annuitization dates and survivorship event specifications that are possible and would be apparent to one of ordinary skill in the art. Using 2001 VBT (Valuation Basic Tables) data, a result of the survivorship specification step, 210, would be a matrix showing the probabilities of survival from annuity purchase age to the specified annuitization age as illustrated in the following table:

TABLE 5
Survivorship Probabilities for Age of Annuity Purchase and Annuitization Date

| | | Age of Annuitization | | | | | | | | |
|---|---|---|---|---|---|---|---|---|---|---|
| | | 50 | 55 | 60 | 65 | 70 | 75 | 80 | 85 | 90 |
| Age of | 30 | 0.970 | 0.951 | 0.919 | 0.868 | 0.790 | 0.679 | 0.526 | 0.338 | 0.158 |
| Purchase | 35 | 0.977 | 0.958 | 0.927 | 0.876 | 0.797 | 0.685 | 0.531 | 0.341 | 0.159 |
| | 40 | 0.984 | 0.966 | 0.937 | 0.888 | 0.808 | 0.694 | 0.538 | 0.345 | 0.162 |
| | 45 | 0.992 | 0.977 | 0.948 | 0.901 | 0.827 | 0.710 | 0.551 | 0.353 | 0.165 |
| | 50 | 1.000 | 0.989 | 0.965 | 0.920 | 0.847 | 0.731 | 0.567 | 0.364 | 0.170 |
| | 55 | 1.000 | 1.000 | 0.984 | 0.946 | 0.875 | 0.762 | 0.594 | 0.382 | 0.179 |

In Table 5 and pursuant to step 210 of FIG. 2, the probabilities of survival from age of purchase to age of annuitization are calculated using 2001 VBT mortality rates. For example, for an individual who is 40 at the age of annuity purchase, there is a 0.808 probability that this individual (male, nonsmoker, select class) will survive to age 70. The probability of survival goes down as the number of years between age of purchase and age of annuitization goes up. Referring again to FIG. 2, step 220 specifies the nonforfeiture benefits available under the contract. Under state law, most annuities (typically both variable and nonvariable) comply with minimum benefits upon either early surrender of the annuity or upon the death of the measured life. Such benefits are typically referred to as nonforfeiture benefits under state law as the state insurance laws typically mandate that a certain amount of benefits must be paid either upon surrender or to a beneficiary upon death. Generally, variable annuities, however, need not provide either surrender or death benefits under state law. For example, under the New York Insurance Code, section 4223(b)(1)(D), excepts variable annuities from the nonforfeiture requirements. Since, in a preferred embodiment, the VERITAS annuity product of FIG. 2 is a variable annuity, it therefore generally is not required to have either cash surrender or death benefits under state law. Step 220 of FIG. 2 specifies whether a given VERITAS contract has either cash surrender or death benefits (or both). In one preferred VERITAS embodiment, there are neither cash surrender or death benefits. The rationale for excluding both such benefits is that the periodic annuitization payments that can be made commencing at the annuity payment date can be maximized in the absence of such benefits. Referring again to FIG. 2, step 230 is the annuitization specification and optimization step. This step involves: (1) specifying the date of annuitization; (2) providing for a guarantee of the exact or minimum interest rate to be used for annuitization; (3) calculating the conditional expected life span of the measured lives, conditional upon survival to the annuitization date; (4) calculating the periodic annuity payments per dollar of initial purchase consideration to be made at the annuitization date based upon (a) the survivorship probability calculated in step 210; (b) the minimum or exact or range of annuitization interest rates provided or guaranteed; (c) the relevant discount factors between the age of purchase and age of annuitization to be used which is, in a preferred embodiment, responsive to the segregated account specification step, 270 described below; (d) calculation of the exclusion ratio which determines the amount of the periodic annuity payment that may be excluded from gross income for a period of time under the Internal Revenue Code; and (e) other actuarial considerations known to one of skill in the art. In a preferred embodiment, step 230 specifies the exact annuity payment based upon the age of the measured life at the annuitization date to be received. This may be specified on a monthly, quarterly, annual or other periodic basis. In a preferred embodiment, this rate will be guaranteed by the issuing company, 240, so that, should interest rates decline in the interim between the annuity purchase date and the annuitization date, the annuity payee will receive periodic annuity payments with the higher guaranteed rate. In the same preferred embodiment, if interest rates are higher at the time of the annuitization date, the annuity payee will receive the guaranteed rate and will not have the option to receive a lump sum from the issuing company. In this way, the annuity payee receives the benefit of a guaranteed rate should future rates decline, but gives up the benefit of a higher future interest rate should rates go up. In this arrangement, since the annuity payee benefits from lower interest rates but does not benefit from higher rates, the issuing company is effectively short a long dated interest rate forward contract and the annuity payee is effectively long a long dated interest rate forward. By not giving the annuity payee the benefit of higher interest rates, the issuing company, 240, takes less interest rate risk and can therefore guarantee the highest possible annuity payment to the annuity payee. In another preferred embodiment, the issuing company, 240, may guarantee a minimum annuity periodic annuity payment and allow the annuity payee to have the benefit of higher future interest rates by, for example, electing to take a lump sum distribution at the annuity payment date. In this preferred embodiment, since the annuity payee is effectively long a floor on future interest rates and the issuing company, 240, is short this floor, making the guarantee more risky for the issuing company.

To illustrate the embodiment in which the issuing company, 240, guarantees an exact period annuity payment at the annuity payment date and using 2001 VBT tables for select nonsmoking males, the following table shows the conditional expected life span and the annual annuity payments that would be made at each annuitization age (annuity payment date):

TABLE 6
Annual Annuity Payments at Annuity Payment Date Assuming Interest Rate of 5.5%

| | Age of Annuitization | | | | | | | | |
|---|---|---|---|---|---|---|---|---|---|
| | 50 | 55 | 60 | 65 | 70 | 75 | 80 | 85 | 90 |
| Cond Exp LE | 31.058 | 26.915 | 23.053 | 19.672 | 16.415 | 13.661 | 10.600 | 7.725 | 5.020 |
| Annual Annuity Rate | 6.79% | 7.21% | 7.76% | 8.45% | 9.41% | 10.60% | 12.70% | 16.24% | 23.34% |

For simplicity, Table 6, assumes a constant annuitization interest rate of 5.5%. In a preferred embodiment, the interest rate to be guaranteed for the purposes of calculating the guaranteed periodic annuity payments will differ depending upon the duration (conditional life expectancy) of the measured life at the annuity payment date. Typically, this rate will be higher for measured lives which are younger at the annuity payment date and lower for measured lives which are older in order to be consistent with the typical upward sloping character of the U.S. Treasury curve. As can be seen from the illustrations of Table 6, the annual payment for an annuity payee based upon a measured life which is 50 years old at the annuity payment date is 6.79% per annum of annuity purchase price and increases to well over 20% for a measured life who is 90 years old at the annuity payment date.

Another step in the annuitization specification is to calculate the discount factors between the age of annuity purchase and the date at which annuity payments begin. To illustrate, the below Table 7 shows such discount factors for various illustrative annuity purchase dates and annuitization dates. For purposes of illustrative simplicity, a flat 5.5% interest rate has been used for all of the calculations:

TABLE 7
Discount Factors Assuming a Flat Interest Rate of 5.5%

| | | Age of Annuitization | | | | | | | | |
|---|---|---|---|---|---|---|---|---|---|---|
| | | 50 | 55 | 60 | 65 | 70 | 75 | 80 | 85 | 90 |
| Age of | 30 | 0.343 | 0.262 | 0.201 | 0.154 | 0.117 | 0.090 | 0.069 | 0.053 | 0.040 |
| Purchase | 35 | 0.448 | 0.343 | 0.262 | 0.201 | 0.154 | 0.117 | 0.090 | 0.069 | 0.053 |
| | 40 | 0.585 | 0.448 | 0.343 | 0.262 | 0.201 | 0.154 | 0.117 | 0.090 | 0.069 |
| | 45 | 0.765 | 0.585 | 0.448 | 0.343 | 0.262 | 0.201 | 0.154 | 0.117 | 0.090 |
| | 50 | 1.000 | 0.765 | 0.585 | 0.448 | 0.343 | 0.262 | 0.201 | 0.154 | 0.117 |
| | 55 | 1.000 | 1.000 | 0.765 | 0.585 | 0.448 | 0.343 | 0.262 | 0.201 | 0.154 |

As can be seen, the longer the time between annuity purchase and annuitization age, the smaller the discount factor. As is shown below, in a preferred embodiment, the smaller the discount factor the greater the annuity payment that can be made beginning on the annuity payment date.

As another step in annuitization specification and optimization, 230, of FIG. 2, the annual annuity payment per dollar of annuity purchase price at the annuity purchase payment date is calculated using the following formula:

$${a}_{t , T} = \frac{{a}_{T}}{{p}_{t , T} {D}_{t , T}}$$

where a_{t,T} represents the annual annuity payment that to be made, as a percentage of annuity purchase price, for a measured life of age t at annuity purchase date and age T at annuity payment date, a_{T} is equal to the annual annuity payment that may be paid to the annuity payee based upon a measured life of age T at the annuity payment date, p_{t,T}, as defined above, the probability of the measured life surviving from age t to T, and D_{t,T} are the interest rate discount factors from time t to T.

To illustrate using the above data in Tables 5 (p_{t,T}), Tables 6 (a_{T}) and Table 7 (D_{t,T}), the following annual annuity payments may be made for a VERITAS annuity of the present invention purchased on the indicated annuity purchase date and annuity payments paid on the indicated annuitization date (annuity payment date) as expressed per dollar of purchase price at the annuity purchase date:

TABLE 8
VERITAS Illustrative Annual Annuity Payments Per Dollar of Annuity Purchase

| | | Age of Annuitization | | | | | | | | |
|---|---|---|---|---|---|---|---|---|---|---|
| | | 50 | 55 | 60 | 65 | 70 | 75 | 80 | 85 | 90 |
| Age of | 30 | 20.4% | 28.9% | 42.1% | 63.4% | 101.3% | 173.7% | 350.8% | 913.4% | 3667.0% |
| Purchase | 35 | 15.5% | 21.9% | 31.9% | 48.0% | 76.8% | 131.7% | 266.0% | 692.7% | 2780.7% |
| | 40 | 11.8% | 16.6% | 24.2% | 36.3% | 58.0% | 99.4% | 200.9% | 523.0% | 2099.7% |
| | 45 | 8.9% | 12.6% | 18.3% | 27.4% | 43.4% | 74.4% | 150.3% | 391.2% | 1570.5% |
| | 50 | NA | 9.5% | 13.7% | 20.5% | 32.4% | 55.3% | 111.7% | 290.7% | 1167.1% |
| | 55 | NA | NA | 10.3% | 15.2% | 24.0% | 40.6% | 81.5% | 212.1% | 851.5% |

To illustrate step of 230 of FIG. 2, a 35 year old male, under the assumptions of the present invention, can receive 131.7% of every dollar of annuity purchase each year for the rest of his life provided the individual (if the measured life and the payee) survives to age 75. Thus, if the annuity purchase price at age 35 were, for example, $100,000, and if the measured life and payee were the same person and the measured life survived to age 75, the payee would receive $131,700 per annum for the rest of his life. As can be seen the VERITAS has very powerful lifecycle savings features, particularly as a source of retirement income where individuals are in a consumption rather than saving phase of their lives.

In a preferred embodiment, the data in Table 8 would be published to prospective buyers of the VERITAS annuity periodically.

Referring again to FIG. 2, step 260, is the owner identification step. The interested parties to a VERITAS annuity include the owner, the measured life, and the annuity payee. These need not be all the same individual nor need the owner or payee be natural persons (the measured life is a natural person). The owner of the VERITAS may, for example, be the measured life, a partnership, a corporation, or a nonprofit organization. An advantage of the present invention, is that, in a preferred embodiment, the segregated accounts of the VERITAS, contain income tax free financial instruments or securities, such as municipal bonds. Under the Internal Revenue Code, no current tax would therefore be payable by a non-natural owner of the VERITAS.

Referring to step 270, in a preferred embodiment the segregated account of the VERITAS will contain zero coupon municipal bond securities the duration of which matches the time between the annuity purchase date and the annuity payment date. Other types of investment instruments or securities may be used. However, zero coupon municipal bond securities have many advantages notwithstanding the tax-free accumulation of taxable financial instruments within a variable annuity account (for natural person owners). First, zero coupon municipal bonds (which may, in a preferred embodiment be either zero coupon bonds issued by state and local governments or may be “strips”—a zero coupon bond constructed by separating the principal portion of a coupon bearing municipal bond from its coupons) are tax-free. While segregated accounts accumulate tax-free within an annuity such as VERITAS (a variable annuity), income taxes are due at the annuity payment date. If municipal bonds are used inside the segregated account, there are no taxes due at the annuitization date in a preferred embodiment. As a consequence, the portion of the periodic annuity payments that are excludable from income tax are much larger. For example, at age 70, the exclusion ratio—that portion of the periodic annuity payment not subject to income tax—would be approximately 65-70% or more. If the segregated account contained taxable investments, this percentage could be 10% or lower depending upon investment returns. Second, long-dated zero coupon municipal bonds are relatively inexpensive in relation to long term Treasury securities. For example, on May 24, 2004, the 30 year Treasury bond yield was equal to 5.45%. A 30 year zero coupon municipal bond, rated AAA, had a similar yield. Thus, the numbers illustrated in Table 8 are plausible illustrations based upon market data. Third, municipal bonds can be insured and are typically issued to have a AAA rating, which, when included inside a AAA annuity issued by an issuing insurance company, 240, provides credit security comparable to a U.S. Treasury bond. Referring above to Table 8, a 30 year old concerned about retirement can derive a large amount of utility from the VERITAS product of the present invention which he cannot do with current products. If this individual desires to retire, for example, at age 70, every dollar invested in a VERITAS annuity at age 30 will product one dollar of annual income at age 70 for the remainder of the individual's life. Furthermore, the annual annuity payments beginning at age 70 will be largely free of tax for many year (until the measured life attains his Internal Revenue Code defined life expectancy). And the individual will have security comparable to the U.S. Treasury securities or other government obligations in a preferred embodiment if AAA zero coupon municipal securities are used in step 270 and a AAA issuing insurer (e.g., Jefferson Pilot, AIG) is used per step 240.

In the preceding specification, the present invention has been described with reference to specific exemplary embodiments thereof. Although many steps have been conveniently illustrated as described in a sequential manner, it will be appreciated that steps may be reordered or performed in parallel. It will further be evident that various modifications and changes may be made therewith without departing from the broader spirit and scope of the present invention as set forth in the claims that follow. The description and drawings are accordingly to be regarded in an illustrative rather than a restrictive sense.

What is claimed is:

1. A method, system, and life insurance product for efficient lifecycle investing, comprising the step of:
identifying multiple insured lives to be insured in a novel universal life insurance policy, specifying the event upon which the death benefit is to be paid among the multivariate events of the timings of the deaths of the insureds, calculating the corridor amount of the contract under Section 7702 of the Internal Revenue Code, optimizing the corridor amount responsive to the number of insureds, their age, and the desired corridor, and specifying the duration of the contract.

2. A method, system, and annuity product for efficient lifecycle investing, comprising the step of:
identifying a plurality of measured lives to in a novel variable annuity contract, specifying the survivorship event or events upon which the periodic annuity payments are conditional, providing for no cash surrender, death, or other nonforfeiture benefits in order to maximize annuity payments to each annuity payee, calculating the future annuity payments responsive to the survivorship probability, interest rates, and conditional life expectancies of the measured lives, and selection of zero coupon municipal bonds for the segregated variable annuity investment account which have a duration approximating the time between the annuity purchase date and annuity payment date.
